(19) United States
(12) Patent Application Publication
(10) Pub. No.: US 2026/0298535 A1
(43) Pub. Date: Oct. 1, 2026

(54) SLIDE SQUEEGEE

(71) Applicants: Dennis Evan Sharek, JR., Lewis Center, OH (US); Ralph Xavier Sharek, Lewis Center, OH (US)

(72) Inventors: Dennis Evan Sharek, JR., Lewis Center, OH (US); Ralph Xavier Sharek, Lewis Center, OH (US)

(21) Appl. No.: 19/562,716

(22) Filed: Mar. 10, 2026

Related U.S. Application Data
(60) Provisional application No. 63/769,703, filed on Mar. 10, 2025.

(51) Int. Cl. F26B 5/14; A47L 13/11; A47L 13/42; A47L 13/50; A63G 21/02

(52) U.S. Cl. CPC F26B 5/14; A47L 13/11; A47L 13/42; A47L 13/50; A63G 21/02

(57) ABSTRACT

A compact collapsible squeegee with a flexible or adjustable blade suitable for wiping fluids from surfaces having various topographies.

### FIELD OF THE DISCLOSURE

The present disclosure relates to squeegees for wiping fluids from surfaces having various topographies. Particularly, this invention relates to squeegee devices suitable for wiping rain and other accumulated liquids from playground slides.

### BACKGROUND

There exist various squeegees and apparatuses for removing fluids from surfaces, including towels and flat squeegees. A conventional squeegee typically comprises an elongated handle section with a rubber blade, mounted in a blade carrier, situated perpendicularly to the elongated handle and affixed at its midpoint to one end of the elongated handle.

There exists an unfulfilled need for a portable squeegee with a compact design and an adjustable or flexible rubber blade suitable for wiping fluids off of playground slides.

### SUMMARY OF THE DISCLOSURE

A squeegee is provided comprising a telescoping handle, a wiper support attached to a pivot point on one end of the telescoping handle configured to rotate about the handle, and a flexible wiper blade that can flex in all directions that is situated in the wiper support.

In some embodiments the squeegee has footrests situated on the wiper blade support.

In some embodiments, the squeegee has an absorbent material situated between the wiper support and the handle.

A kit is provided comprising a squeegee comprising a telescoping handle, a wiper support attached to a pivot point on one end of the telescoping handle configured to rotate about the handle, and a flexible wiper blade that can flex in all directions that is situated in the wiper support; at least one replacement flexible wiper; and at least one replacement moisture-wicking element.

A method of drying a playground surface is provided comprising positioning at an upper portion of a wet slide a squeegee comprising a telescoping handle, a wiper support attached to a pivot point on one end of the telescoping handle configured to rotate about the handle, and a flexible wiper blade that can flex in all directions that is situated in the wiper support; applying downward force through the telescoping handle and footrests to promote watertight contact between a flexible wiper and the slide; and moving the squeegee along the slide to shunt liquid from the slide.

Additional features, advantages, and embodiments of the disclosure may be set forth or apparent from consideration of the detailed description and drawings. Moreover, it is to be understood that the foregoing summary of the disclosure and the following detailed description and drawings provide non-limiting examples that are intended to provide further explanation without limiting the scope of the disclosure as claimed.

### DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced.

FIGS. 1 and 2 illustrate a perspective and front view of a squeegee 100 in accordance with embodiments of the present invention. The squeegee 100 has a telescoping handle 102, a wiper support 104 attached to a pivot point 106 on one end of the telescoping handle 102. A flexible wiper 108 is situated in the wiper support 104. The wiper support 104 has footrests 110.

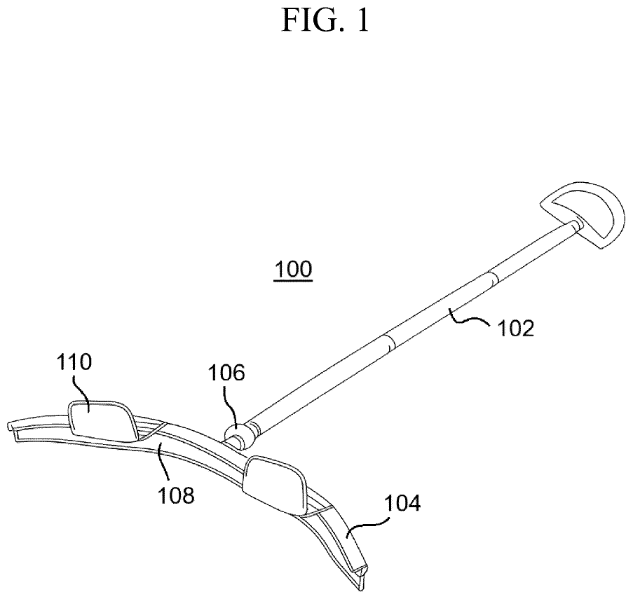

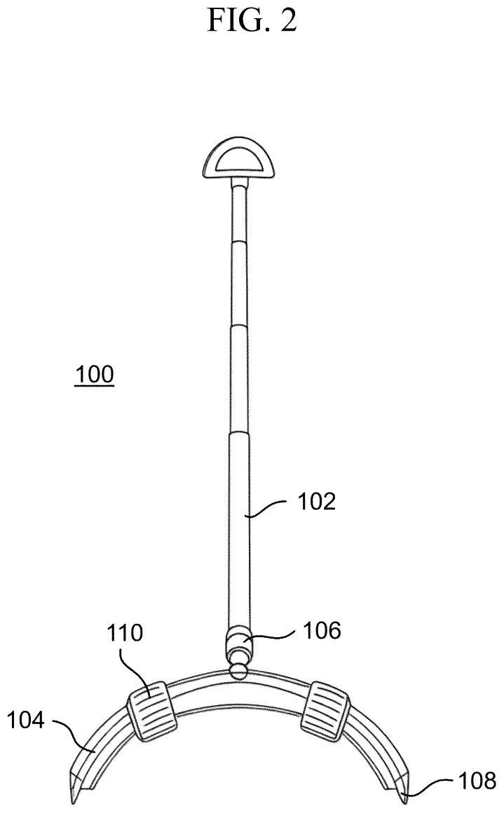

The present disclosure is further described in the detailed description that follows.

### DETAILED DESCRIPTION OF THE DISCLOSURE

The disclosure and its various features and advantageous details are explained more fully with reference to the non-limiting embodiments and examples that are described or illustrated in the accompanying figures and detailed in the following description. It should be noted that features illustrated in the figures are not necessarily drawn to scale, and features of one embodiment can be employed with other embodiments as those skilled in the art would recognize, even if not explicitly stated. Descriptions of well-known components may be omitted so as to not unnecessarily obscure the embodiments of the disclosure. The examples are intended merely to facilitate an understanding of ways in which the disclosure can be practiced and to further enable those skilled in the art to practice the embodiments of the disclosure. Accordingly, the examples and embodiments should not be construed as limiting the scope of the disclosure.

Playgrounds are gathering points for the community, promoting social cohesion and fulfilling socialization needs for children as well as their caregivers. After a rainstorm, on a dewy morning, or for other reasons, there is frequently moisture on playground surfaces. In particular, slides often are coated with liquid and there can often be found pools of liquid, hopefully water, at the base of the slide. When children play on playground equipment, many parts of the playground require only contact between children's feet (often wearing shoes) and hands, so moisture issues are less problematic. However, slides, swings, and several other playground surfaces require children to sit on the surface or otherwise make contact between the surface and clothed portions of their bodies, which are prone to absorbing the moisture and becoming wet. Once children's clothing is wet, children are prone to becoming uncomfortable and becoming cold. Wet clothing wicks away body heat and lowers body temperature. Small children in particular struggle to regulate their body temperature, so wet clothing frequently marks a premature end to a playground session and forces children home to change into dry clothing. This negatively impacts children's social development and community cohesion as a whole.

As previously mentioned, embodiments of the present invention are directed to a novel compact collapsible squeegee with a flexible or adjustable blade suitable for wiping fluids from surfaces.

Slides and other playground surfaces that accumulate water are often curved, rigged, bumpy or otherwise irregular. According to an aspect of the disclosure, an apparatus is provided that includes a flexible or adjustable blade, made of rubber or other flexible material, that, when pressure is applied, adjusts to the varied surface of the playground equipment and permits a close, water-tight contact between the blade and the playground surface. When the device is moved across the surface, water is shunted or squeegeed off of the surface and the surface becomes dry. In some embodiments of the device, trailing behind the rubber blade is a moisture-wicking material such as a soft broom, felt, terry-cloth or the like which wicks away any residual moisture left behind after the rubber blade. This absorbent or moisture-wicking material could be situated between the flexible blade and the handle of the device.

The adjustable, flexible blade may be mounted in a blade carrier, or the blade may have a structure around it that permits the blade to be affixed at approximately its midpoint to a handle. The handle can be elongated, or in some embodiments, telescoping. The attachment point where the blade carrier or blade carrying structure meets the elongated handle may include a pivot point, allowing the blade to be folded or collapsed and become perpendicular or approximately perpendicular to the handle. This promotes a portable, compact design appropriate for storing in a backpack, diaper bag or stroller. This allows children in particular to carry the device conveniently to the playground, including by attaching it to a bicycle, scooter, or other child-friendly transportation device, or putting it in their backpack or other carrying system. Unwieldy, large devices are prohibitively cumbersome to carry to and from the playground, reducing utility.

An elongated handle permits a user to position the squeegee ahead of them when moving across a surface or going down a slide, allowing the surface to be dried before any portion of the user's body, including clothed portions, come into contact with wet surfaces. Additionally, elongated handles permit a user to position the squeegee to reach surfaces otherwise out of reach from the ground or their position, including elevated playground platforms, or tops of slides. A telescoping design of the handle permits the handle to be sufficiently elongated to permit a user to reach otherwise out-of-reach surfaces from the ground, or to move down a slide feet-first, holding the squeegee in their hands, while drying surfaces below their feet. At the same time, the handle may be telescoped down into a retracted position that is compact and portable. Embodiments of the invention may also employ one or more releasable telescoping handle latches for securing the telescoping handle in an extended position. The one or more releasable telescoping handle latches may be designed so that they are releasable merely by applying hand force to an end of the telescoping hand. In this way, it is unnecessary to release each latch for each section of the telescoping handle. In some embodiments, the telescoping sections are releasable section by section either at the joining of the sections, or from the top end of the handle.

The elongated handle may have a cylindrical outer casing with an extension that telescopes up and out from inside of the outer casing. The handle may also be square, oval or any other shape. Situated at one end of the telescoping extension is a swivel head that can include wiper blade support for a standard wiper blade, or a standard wiper blade and a sponge, cloth or wiping material on the other side within a support mechanism. The outer casing of the handle may be used as a grip for the operator, or on the end of the elongated handle opposite of the blade there may be a handle, including a gripper. In some embodiments, the handle portion is perpendicular to the elongated handle and extends into handlebars. On the handle there may be buttons that release the telescoping handle from a retracted position, release the blade at the pivot point from the secured position, and/or lock the blade in place to prevent or limit swiveling. In some embodiments, there are two elongated handles fixed to either end of the blade holder or wiper support.

The blade, which may pivot around the handle in order to be situated approximately parallel to the handle and be collapsed or folded for portability, can also lock into position or lock into one of many variable positions (either in a step-wise fashion, with discrete positions with a racheting mechanism, or at any of an infinite number of positions in a continuum of positions along a smooth mechanism) to accommodate different playground surfaces and to prevent the blade from swiveling during use. Alternatively, the blade can be semi-locked, permitting only a limited degree of swiveling to accommodate even more types of surfaces.

The blade portion of the squeegee can thus lock into a position perpendicular from the handle, but can also be latched into a position approximately parallel with the handle. Alternatively, the blade portion can also be sized to fit into a channel or groove of the handle portion so that they fold into one another. In still another embodiment, the telescoping handle is sized to fit into a channel or groove of the blade portion so that the handle fits into the blade portion.

In some embodiments, the squeegee has footrests, to allow the user to leverage the weight of their feet to promote close, watertight contact between the squeegee portion of the device (e.g., the rubber blade) and the playground surface and/or to provide stability and allow for a user to securely hold the device. The footrests can be directly attached to the squeegee portion of the device (e.g., the blade, the blade holder or wiper support), or can be situated independent from the squeegee, e.g., situated between the squeegee portion of the device and the handle or affixed to the handle. The footrests may be fixed, pivotable, or retractable. By enabling the user to leverage body weight rather than relying solely on arm strength, the footrests improve control during operation, particularly on inclined, uneven, or textured surfaces such as the curved contours of slides. The footrests may include textured, ribbed, or slip-resistant surfaces to enhance traction and safety during use, and may be dimensioned to accommodate users of varying sizes, including children. In some embodiments, the footrests cooperate with the flexible blade to maintain uniform pressure across irregular terrain, thereby increasing the effectiveness of fluid removal and further reducing residual moisture on the treated surface.

In some embodiments, when a user engages the footrest, force vectors are directed through the footrest bracket into the wiper support and toward the flexible wiper, increasing contact pressure at the wiper edge. A downward force applied by a user's foot is transmitted directly through the wiper support to the flexible wiper. The proximity of the footrest to the wiper edge reduces bending moments in the handle and improves the consistency of the squeegee action across curved, ribbed, or otherwise uneven surfaces. In some embodiments, the pivot joint between the wiper support and the handle is configured in a semi-locked mode, allowing limited angular compliance while resisting uncontrolled swiveling; this semi-lock cooperates with footrest loading to maintain an effective squeegee angle relative to the surface. The footrest may be movable between a deployed position and a stowed position to facilitate compact storage and transport. The footrest platform can present an upper stepping surface with a slip-resistant texture, such as a molded chevron pattern, raised ribs, knurling, or an applied elastomer overmold. In some embodiments, the footrest is largely one surface. In others, a pair of footrests is provided on opposite lateral sides of the wiper support to enable two-foot engagement for increased stability and more uniform contact.

The blade of the squeegee is flexible and adaptable so as to closely adhere to the surface that is uneven, curved, ridged, ribbed, and the like. This close abutment of the squeegee surface with the playground surface may be facilitated by a very flexible blade, potentially made of rubber, silicone, or a number of flexible materials. In other embodiments, the blade is made of many individual flexible sections that move independently of one another to closely match a ridged, ribbed or otherwise uneven surface.

The blade may flex up and down, forward and backwards, or in any direction. For example, some portions of the blade may be flexing forward and down, while at the same time another portion may be flexing down and backward. In this way, close contact between the surface and the squeegee may be achieved to ensure water is shunted away from the surface.

A kit may be provided that is comprised of the slide squeegee disclosed herein, a replacement flexible wiper, and a replacement moisture-wicking element. Such moisture-wicking element may be machine washable, antimicrobial, or have other features appealing for playground-goers.

Disclosed herein is a method of drying playground surfaces, including slides, by using the squeegee disclosed herein to apply downward force through the telescoping handle and/or footrests to promote watertight contact between the flexible blade and the playground surface, shunting liquid from the playground surface. In some methods, residual moisture is also absorbed with a moisture-wicking element following closely behind he flexible blade.

In summary, the embodiments described herein provide a portable, collapsible squeegee device that enables users to remove moisture efficiently from a wide range of irregular playground surfaces. The device employs a flexible or adjustable blade capable of conforming to curved, ribbed, or otherwise uneven structures, thereby promoting close contact and effective fluid removal. Optional moisture-wicking materials may further enhance drying performance by absorbing residual liquid. The handle, which may be elongated or telescoping, facilitates access to elevated or distant surfaces while permitting compact storage when not in use. Various locking, pivoting, and latching mechanisms can secure the blade and handle in multiple orientations to accommodate diverse operating conditions. In some embodiments, the device further includes one or more footrests that allow the user to apply downward force with their feet, thereby increasing stability and promoting firm, uniform pressure between the blade and the treated surface. Collectively, these features support a lightweight, user-friendly tool that improves the usability of playground equipment following precipitation or dew accumulation and extends the duration and comfort of outdoor play.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

What is claimed is:

1. A squeegee, comprising:
a telescoping handle;
a wiper support attached to a pivot point on one end of the telescoping handle configured to rotate about the handle;
a flexible wiper that can flex in all directions situated in the wiper support.

2. The squeegee of claim 1, wherein the wiper support is coupled to at least one footrest.

3. The squeegee of claim 2, wherein the at least one footrest is positioned on opposite sides of the wiper support to allow two-foot engagement and to promote uniform pressure distribution along a length of the flexible wiper.

4. The squeegee of claim 1, wherein the telescoping handle has a channel configured to receive the wiper support when the wiper support is rotated.

5. The squeegee of claim 1, wherein the pivot point comprises a semi-lock assembly configured to allow limited swiveling of the wiper support during use.

6. The squeegee of claim 1, further comprising a moisture-wicking element disposed adjacent the flexible wiper and configured to absorb residual liquid.

7. The squeegee of claim 1, further comprising at least one releasable telescoping handle latch configured on the telescoping handle to secure the telescoping handle in an extended position.

8. A method of drying a playground surface, comprising:
positioning at an upper portion of a wet slide a squeegee according to claim 2;
applying downward force through the telescoping handle and footrests to promote watertight contact between a flexible wiper and the slide; and
moving the squeegee along the slide to shunt liquid from the slide.

9. A kit, comprising:
a squeegee according to claim 1;
at least one replacement flexible wiper; and
at least one replacement moisture-wicking element.

10. The kit of claim 9, further comprising an adapter configured to mount a standard wiper blade to the wiper support.
